(19) United States
(12) Patent Application Publication
(10) Pub. No.: US 2026/0234955 A1
(43) Pub. Date: Aug. 13, 2026

(54) SHELTER, PARKING SPACE FOR A VEHICLE AND METHOD FOR BUILDING A SHELTER

(71) Applicant: L3V STRATEGIES, ARLES (FR)

(72) Inventor: Pierre ROUCHON, ARLES (FR)

(21) Appl. No.: 19/638,193

(22) Filed: Apr. 3, 2026

Related U.S. Application Data
(63) Continuation-in-part of application No. PCT/EP2024/077678, filed on Oct. 2, 2024.

(30) Foreign Application Priority Data
Oct. 2, 2023 (FR) FR2310525
Dec. 16, 2025 (FR) FR2515447

(51) Int. Cl. E04H 6/02; H02S 20/24

(52) U.S. Cl. CPC E04H 6/025; H02S 20/24

(57) ABSTRACT

The invention relates to a shelter (1) which comprises:
a roof (5);
a pillar (3) which at least partially supports the roof (5) and which comprises:
a sole plate (11);
a beam (12) higher than the sole plate (11);
a plurality of uprights connecting the sole plate (11) and the beam (12) to each other;
a container (25); and
ballast (26) placed in the container (25) so that the sole plate (11) holds at least some of the weight of this ballast (26).

### TECHNICAL FIELD OF THE INVENTION

The present invention relates to a shelter, a parking space for a vehicle and a method for building a shelter.

### STATE OF THE ART

In general, a shelter must be able to resist violent winds without tipping over or being moved. However, the wind load of a shelter increases as its roof gets larger. A shelter for motor vehicles has a large roof, especially if it has a capacity allowing it to shelter a series of several motor vehicles parked side by side.

Among the known shelters, one type of shelter comprises posts whose lower ends are fixed to the ground. Before building a shelter of this type, holes are dug in the ground. Next, the lower end of each post is placed in a previously dug hole, into which concrete is then poured for hardening into a compact mass anchoring the post. In a second step, the rest of the shelter is assembled on the spot, on the posts already anchored in the ground.

A shelter is also known that can be installed directly on a ground, without needing to dig holes for posts in the ground. Such a shelter can be partially or completely preassembled.

This known shelter with no ground-anchored post comprises concrete blocks resting on the ground. These concrete blocks are bases to which a framework supporting a roof is fixed. Each concrete block has a significant mass. In the case where the known shelter with no ground-anchored post is intended to shelter motor vehicles, each of its concrete blocks therefore weighs several tonnes. The transport, handling and installation of such concrete blocks is difficult and costly, requiring lifting machinery.

### SUMMARY OF THE INVENTION

A shelter comprises a pillar which at least partially supports a roof. This pillar comprises a sole plate and a container. The sole plate receives at least part of the weight of the ballast placed in the container.

At least one aim of the invention is to facilitate the installation of a shelter.

To this end, according to a first aspect, this invention envisions a shelter, which comprises:
a roof;
a pillar which at least partially supports the roof and which comprises:
   a sole plate;
   a beam higher than the sole plate;
   a plurality of uprights connecting the sole plate and the beam to each other;
   a container; and
   ballast placed in the container so that the sole plate holds at least some of the weight of this ballast;
      wherein the container and the ballast run between the upright, and the ballast comprises a gabion or a set of gabions comprising a fragmented material.

The shelter defined above has the advantage that it can be at least partially preassembled, i.e. at least partially assembled prior to its installation.

The sole plate holds at least part of the weight of the ballast directly from this ballast and/or indirectly. According to one possibility, the container rests at least partially on the sole plate, and the ballast is placed in the container so that the container applies at least part of the weight of the ballast on the sole plate.

In some embodiments, the ballast is placed in the container so that the sole plate holds at least part of the weight of the ballast directly from this ballast and/or so that the container applies at least part of the weight of the ballast on the sole plate.

The shelter defined above can incorporate one or more other advantageous characteristics, individually or in combination, in particular among those defined below.

Thus, the uprights can hold the container and ballast between them, such that the container obtains lateral stiffness because of the presence of the uprights. Its structure can therefore be lighter for the same ballast mass.

In some embodiments, the container and ballast form part of a wall.

In this way, the wall effectively prevents the tilting of the sole plate in an upright plane containing the longitudinal direction of the wall.

In some embodiments, the sole plate is elongated and has generally the same longitudinal direction as the wall.

In some embodiments, the pillar is a first pillar, the shelter comprising a second pillar which partially supports the roof, the first and second pillars being separated from each other along a direction crossing the longitudinal direction of the wall.

In this way, a large available free surface can be obtained, on the ground, e.g. for parking vehicles. It can be obtained at the same time as great stability of the shelter, including in strong winds.

In some embodiments, a lower end of a first of the uprights and a lower end of a second of the uprights are immobilised on the sole plate, the sole plate maintaining a separation distance between the lower end of the first upright and the lower end of the second upright.

In this way, robustness of the pillar in an upright plane can be obtained.

In some embodiments, together, the first upright and the second upright essentially form a V whose opening faces downwards.

Thus, the shelter can have a simplified composition, which can result in easier adjustments, easier production and/or a lower production cost.

In some embodiments, the separation distance between the lower end of the first upright and the lower end of the second upright is along the longitudinal direction of the wall.

In this way, stability and robustness of the pillar can be obtained in an upright plane containing the longitudinal direction of the wall. At the same time, a large available free surface can be obtained, on the ground, e.g. for parking vehicles. For example, one or more parking spaces parallel to the wall can be adjacent to it.

In some embodiments, an upper end of the second upright and an upper end of a third of the uprights are immobilised on the beam, the beam having a longitudinal direction which is substantially parallel to the same upright plane as the longitudinal direction of the wall, the beam maintaining a separation distance along the longitudinal direction of the beam, between the upper end of the second upright and the upper end of the third upright.

In this way, stability and robustness of the pillar can be obtained in an upright plane containing the longitudinal direction of the wall.

In some embodiments, together, the second upright and the third upright essentially form a V whose opening faces upwards.

Thus, the shelter can have a simplified composition, which can result in easier production and/or a lower production cost.

In some embodiments, the roof comprises a roof covering that comprises photovoltaic panels.

In some embodiments, the ballast is not secured to the container.

In this way, the ballast can be easily removed from the container, during a partial or complete dismantling of the shelter, replacement of the container and/or ballast, movement of the shelter, repositioning of the shelter, and/or a complete removal of the shelter.

The subject of the invention is also a parking space for a vehicle, comprising a shelter as defined above, and a parking area for a vehicle located under the roof of the shelter.

According to a second aspect, the present invention envisions a method for building a shelter, as defined above, which method comprises steps in which:
a) the sole plate is placed on a ground, then
b) the ballast is placed in the container that is in place relative to the sole plate so that the sole plate holds at least part of the weight of the ballast once this ballast is in the container.

In some embodiments, the building method comprises a step that precedes step b), in which the position, on a ground, and/or the orientation, around a vertical axis, of a structure comprising the sole plate, beam and uprights are adjusted.

As the particular aims, advantages and features of the method that is the subject of the present invention are similar to those of the shelter that is the subject of the present invention, they are not repeated here.

In some embodiments, the ballast comprises a first material and the sole plate comprises an upper perforated support. The sole plate also comprises, below this perforated support, a second fragmented material, the fragments of which are configured to pass through the through-openings of this perforated support.

In some embodiments, the ballast comprises a first material. The sole plate comprises a second fragmented material and a lower bearing surface resting on the ground and, on the exterior of this lower bearing surface, a vertical or oblique rigid skirt extending, downwards, at least to the location of the lower bearing surface.

In some embodiments, the ballast comprises at least a fragmented material and the container comprises frontal surfaces and lateral surfaces, and at least one interior brace traversing the volume of the container between two of said surfaces, the container comprising an attachment means for attaching each end of said interior brace to one of the surfaces between which this interior brace extends.

In some embodiments, the container comprises:
on at least one upright, a comb having teeth perpendicular to the surface of the container and turned towards the interior of the container; and
at least one screen comprising aligned through-openings traversed by teeth of a said comb.

According to a third aspect, this invention envisions a shelter, which comprises a roof and at least one pillar which at least partially supports the roof, at least one said pillar comprising:
a sole plate;
a support beam supporting the roof;
a plurality of uprights connecting the sole plate and the beam;
a container held in position by the uprights; and
ballast placed in the container such that the sole plate holds at least some of the weight of this ballast;
   a shelter in which the ballast comprises a first material, the sole plate comprises an upper perforated support and, below this perforated support, a second fragmented material, the fragments of which are configured to pass through the through-openings of this perforated support.

In some optional embodiments, the sole plate comprises a second fragmented material and a lower bearing surface resting on the ground and, on the exterior of this lower bearing surface, a vertical or oblique rigid skirt extending, downwards, at least to the location of the lower bearing surface.

In some optional embodiments, the first material is fragmented and graded, its fragments conforming to a geometric size, and in which the through-openings of the perforated support are configured to prevent the passage of the first material.

In some optional embodiments, the perforated support comprises parallel profiles.

In some optional embodiments, the distance between the profiles is less than the smallest dimension of the smallest graded fragment of the first fragmented material.

In some optional embodiments, the distance between the profiles is less than half the smallest dimension of the smallest graded fragment of the first fragmented material.

In some optional embodiments, the largest dimension of the fragments of the second fragmented material is less than half the smallest dimension of the smallest graded fragment of the first material.

In some optional embodiments, the rigid skirt is vertical, the bearing surface comprises “U”-shaped lateral surfaces inclined at 90 degrees and/or the rigid skirt is held in position by a “Z”-shaped part having right angles, itself fixed to the vertical interior surface of the profiles.

In some optional embodiments, the container comprises frontal surfaces and lateral surfaces, and at least one interior brace traversing the volume of the container between two of said surfaces, the container comprising an attachment means for attaching each end of said interior brace to one of the surfaces between which this interior brace extends.

In some optional embodiments, the container comprises:
on at least one upright, a comb having teeth perpendicular to the surface of the container and turned towards the interior of the container; and
at least one screen comprising aligned through-openings traversed by teeth of a said comb.

According to a fourth aspect, this invention envisions a shelter, which comprises a roof and at least one pillar which at least partially supports the roof, at least one said pillar comprising:
a sole plate;
a support beam supporting the roof;
a plurality of uprights connecting the sole plate and the beam;
a container held in position by the uprights; and
ballast placed in the container such that the sole plate holds at least some of the weight of this ballast;
   a shelter in which the ballast comprises a first material, the sole plate comprises a second fragmented material and a lower bearing surface resting on the ground and, on the exterior of this lower bearing surface, a vertical or oblique rigid skirt extending, downwards, at least to the location of the lower bearing surface.

In some optional embodiments, the rigid skirt is vertical.

In some optional embodiments, the bearing surface comprises “U”-shaped lateral surfaces inclined at 90 degrees.

In some optional embodiments, the rigid skirt is held in position by a “Z”-shaped part having right angles, itself fixed to the vertical interior surface of the profiles.

According to a fifth aspect, this invention envisions a shelter which comprises a roof and at least one pillar which at least partially supports the roof, at least one said pillar comprising:
a sole plate;
a support beam supporting the roof;
a plurality of uprights connecting the sole plate and the beam;
a container held in position by the uprights; and
ballast placed in the container such that the sole plate holds at least some of the weight of this ballast;
   a shelter in which the ballast comprises at least a fragmented material and the container comprises frontal surfaces and lateral surfaces, and at least one interior brace traversing the volume of the container between two of said surfaces, the container comprising an attachment means for attaching each end of said interior brace to one of the surfaces between which this interior brace extends.

According to a sixth aspect, this invention envisions a shelter which comprises a roof and at least one pillar which at least partially supports the roof, at least one said pillar comprising:
a sole plate;
a support beam supporting the roof;
a plurality of uprights connecting the sole plate and the beam;
a container held in position by the uprights; and
ballast placed in the container such that the sole plate holds at least some of the weight of this ballast;
   a shelter in which the container comprises:
on at least one upright, a comb having teeth perpendicular to the surface of the container and turned towards the interior of the container; and
at least one screen comprising aligned through-openings traversed by teeth of a said comb.

The fundamental or optional features of the various aspects of the invention are intended to be combined to form particular embodiments of the shelter that is the subject of the invention.

### BRIEF DESCRIPTION OF THE FIGURES

Other advantages and features will become clearer from the description that follows of particular embodiments of the invention, given as non-limiting examples represented in the drawings included in an appendix, of which:

FIG. 1 is a schematic view, in perspective, in which a shelter according to a first embodiment of the invention is being installed, and thus always without its ballast, on a parking ground;

FIG. 2 is a schematic side view in which the shelter visible in FIG. 1 has been completed;

FIG. 3 is a schematic front view which represents the same completed shelter as in FIG. 2;

FIG. 4 is a detailed view which represents a portion of the ground in cross-section and a lower portion of a constitutive structure of the shelter visible in FIGS. 1 to 3;

FIG. 5 is a logical diagram representing the steps of a method according to an embodiment of the invention which can be utilised for building a shelter according to the first embodiment of the invention;

FIG. 6 is a schematic view, in perspective, in which a shelter according to a second embodiment of the invention is being installed, and thus always without its ballast, on a parking ground,

FIG. 7 is a view, in perspective, of a shelter according to a particular embodiment of the invention during installation, and thus without ballast, on a parking ground;

FIG. 8 is an enlargement of a portion of FIG. 7;

FIG. 9 is an enlargement of a portion of FIG. 8;

FIG. 10 is a side view of the shelter represented in FIG. 7;

FIG. 11 is a front elevation view of the shelter represented in FIG. 7;

FIG. 12 is a plan view of the structure supporting the roofing;

FIG. 13 is a first partial cross-section view of the shelter represented in FIGS. 7 to 12, along a cross-section line “A” represented in FIG. 11;

FIG. 14 is a second partial cross-section view of the shelter represented in FIGS. 7 to 12, along a cross-section line “B” represented in FIG. 10;

FIG. 15 is a third partial cross-section view of the shelter represented in FIGS. 7 to 12, along a cross-section line “C” represented in FIG. 10;

FIG. 16 is a fourth partial cross-section view of the shelter represented in FIGS. 7 to 12, along a cross-section line “D” represented in FIG. 10; and

FIG. 17 is a logical diagram representing the steps of a method that is the subject of the invention according to a particular embodiment utilised for building a shelter represented in FIGS. 7 to 16.

### DESCRIPTION OF THE EMBODIMENTS

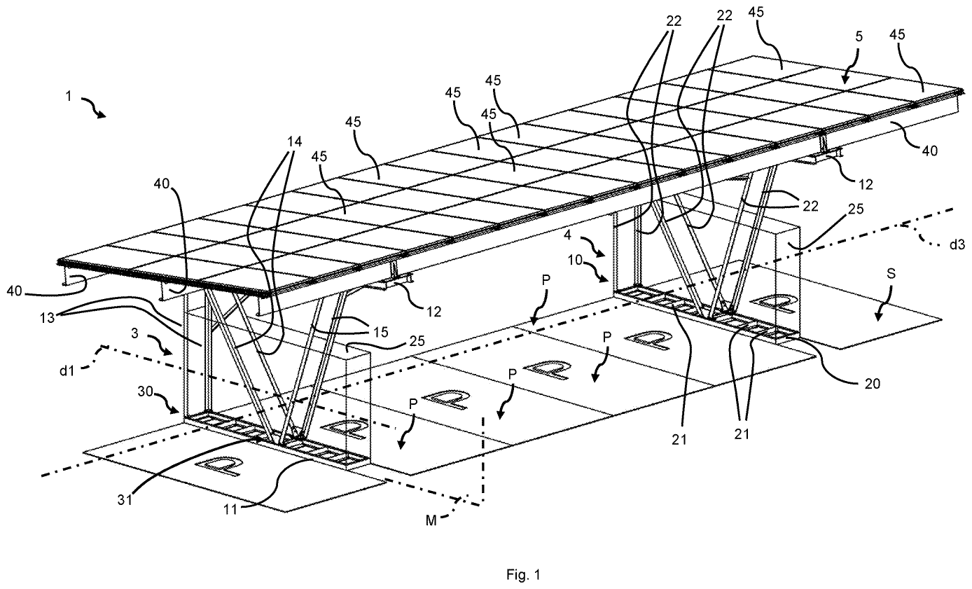

FIG. 1 shows a shelter 1 according to a first embodiment of the invention that does not have its ballast and is on a ground, which is a parking ground S in the example shown. The shelter 1 comprises a pillar 3 and a pillar 4, which together support a roof 5.

In the example shown, pillars 3 and 4 are identical. In what follows, only pillar 3 is described for reasons of clarity. In addition, when they are identical or equivalent, a referenced part of pillar 3 and a referenced part of pillar 4 are designated by the same reference.

Pillar 3 comprises a structure 10 comprising a sole plate 11, an upper beam 12 and a plurality of pair of uprights 13, 14 and 15, which are upright and connect the sole plate 11 and the beam 12 to each other. The sole plate 11, beam 12, pair uprights 13, 14 and 15, and any intermediate parts are held together, for example by bolting, such that the structure 10 is generally rigid.

The sole plate 11 is elongated. Its longitudinal direction is referenced d1.

The sole plate 11 is a rigid sub-structure of the structure 10. The sole plate 11 comprises a rectangular frame 20, and a series of cross members 21, each cross member having two opposite ends at least held down by this frame 20. In the example shown, each end of any cross member 21 is held down by an inner edge of the frame 20.

Each of pair of uprights 13, 14 and 15 comprises two uprights 22, which are generally parallel to each other. Each upright 22 has a lower end fixed directly or indirectly to the sole plate 11 and an upper end fixed directly or indirectly to the beam 12.

Pillar 3 comprises a container 25, which is elongated so as to have generally the same longitudinal direction d1 as the sole plate 11. The container 25 rests on the sole plate 11, over the sole plate's entire length. The container 25 rests in particular on the cross members 21.

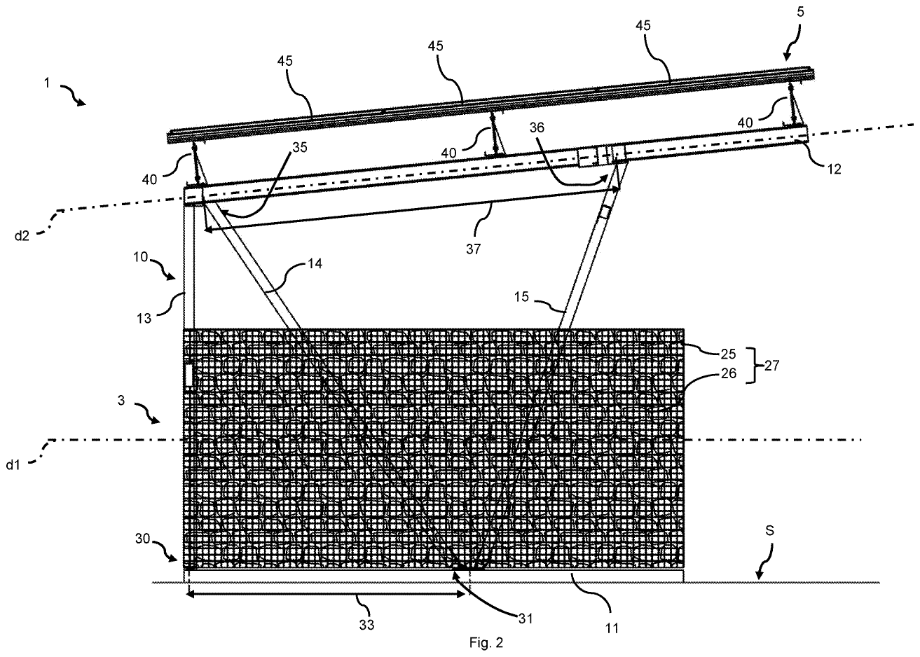

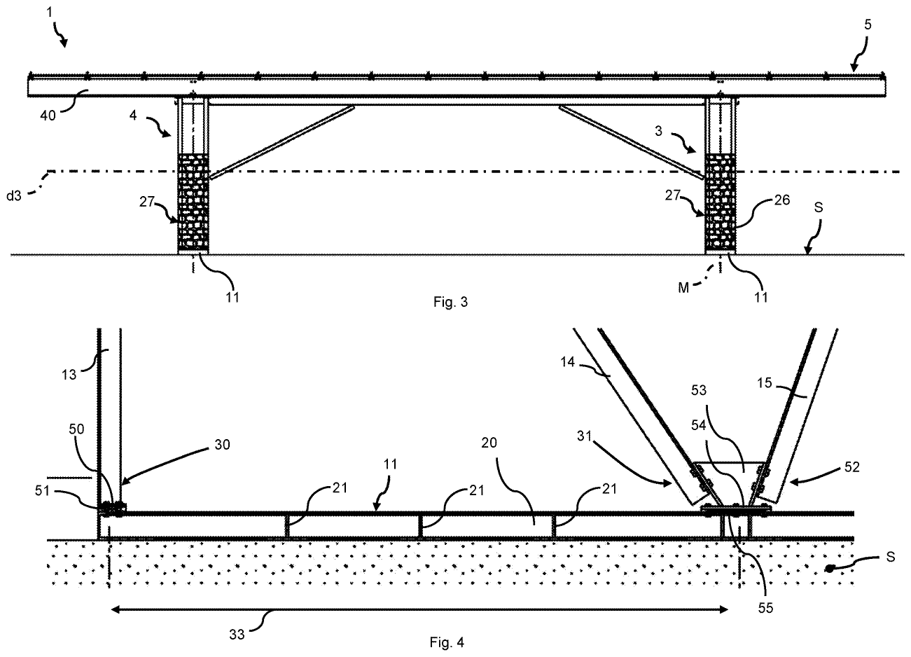

In FIGS. 2 and 3, the shelter 1 is completed. Pillar 3 of the completed shelter 1 comprises ballast 26 which has been placed in the container 25 so that the container 25 applies the weight of the ballast 26 on the sole plate 11.

The container 25 and the ballast 26 together form a wall 27. Like the container 25, the wall 27 has generally the same longitudinal direction d1 as the sole plate 11.

As can be seen in FIG. 1, the container 25 runs between the upright 22. Similarly, the wall 27 runs between the uprights 22. The two uprights 22 of pair of uprights 14 hold the wall 27 laterally between them. This is also the case with the uprights 22 of pair of uprights 15.

The pairs of uprights 13, 14 and 15 are respectively defining a first pair of uprights, a second pair of uprights and a third pair of uprights.

As can be seen in FIG. 2, a lower end 30 of pair of uprights 13 and a lower end 31 of pair of uprights 14 are immobilised on the sole plate 11, which maintains a separation distance 33 between these lower ends 30 and 31, along a separation direction. This separation direction is the longitudinal direction d1 of the wall 27.

An upper end 35 of uprights 22 of pair of uprights 14 and an upper end 36 of uprights 22 of pair of uprights 15 are immobilised on the beam 12, which maintains a separation distance 37 between these upper ends 35 and 36, along the longitudinal direction d2 of the beam 12.

On each lateral side of the container 25, the upright 22 of the pair of uprights 13 and the upright 22 of the pair of uprights 14 essentially form a V whose opening faces downwards. On each lateral side of the container 25, the upright 22 of the pair of uprights 14 and the upright 22 of the pair of uprights 15 essentially form a V whose opening faces upwards. Together, on each lateral side of the container 25, said uprights essentially form an upright N.

As can be seen in FIG. 2, longitudinal direction d1 and longitudinal direction d2 are contained substantially in the same upright plane, which is referenced M in FIGS. 1 and 3. In the example shown, the upright plane M is generally vertical and the median plane of pillar 3.

Several purlins 40 of the roof 5 rest on the beam 12, to which these purlins 40 are fixed, for example by bolting.

As can be seen in FIG. 1, the roof 5 comprises a roof covering that advantageously comprises photovoltaic panels 45.

FIG. 4 shows a lower portion of the structure 10 and the parking ground S, on which the sole plate 11 rests.

The lower end 30 of uprights 22 of the pair of uprights 13 comprises a fixing flange 50 which is bolted to the sole plate 11. At least one shim 51 is placed between the fixing flange 50 and the sole plate 11. In a different adjustment, no shim is placed between the fixing flange 50 and the sole plate 11.

The lower end 31 of uprights 22 of the pair of uprights 14 and the lower end 52 of uprights 22 of the pair of uprights 15 are held together by an assembly part 53, to which they are bolted. The assembly part 53 comprises a fixing flange 54 which is bolted to the sole plate 11. At least one shim 55 is placed between the fixing flange 54 and the sole plate 11. In a different adjustment, no shim is placed between the fixing flange 54 and the sole plate 11.

The shim(s) 51 and/or shim(s) 55 make it possible to adjust the position of pillar 3 relative to the vertical in the upright plane M, for example if the parking ground S is uneven. Pillar 3 thus comprises means allowing a vertical adjustment, these means comprising the fixing flanges 50 and 54.

The shim(s) 51 and/or shim(s) 55 also make it possible to adjust the height of pillar 3 relative to pillar 4 and, in particular, to position these two pillars 3 and 4 at the same height, for example if the parking ground S is uneven. This possibility of adjustment is even more useful and advantageous in the case where the shelter comprises more than two pillars in succession, for example a third pillar in addition to pillars 3 and 4. This possibility of adjustment is even more useful and advantageous in the case where at least three pillars in succession together support the same one or more purlins 40, generally rectilinear, of the shelter.

The structure 10 is mainly or completely made of metal parts. Other materials are also possible. For example, according to one variant, the structure 10 is mainly or completely made of wooden parts.

The purlins 40 are metal parts. Other materials are also possible. For example, according to one variant, the purlins 40 are wooden parts.

The container 25 comprises a structure selected from among a lattice of interwoven wires, a lattice of battens, sheets and wooden panels. In some embodiments, the wires of the lattice are metallic. Preferably, they are made of steel selected from among stainless steel, galvanised steel and tinned steel. According to a first variant, the container 25 comprises a single compartment. According to a second variant, the container 25 comprises a plurality of compartments. According to a third variant which can be combined to any of these first and second variants, the bottom of the container 25 is a part which can be separated or is initially separate from the rest of this container 25 and which is installed separately, under or between the cross members 21 of the sole plate 11, by fixing it to the underside or to the lower parts of these cross members 21. When this is the case, at least one portion of the ballast 26 bears directly on the sole plate 11, once pillar 3 has been completed.

The ballast 26 consists of rocks, pebbles, stones, gravel, sand, concrete blocks and/or recycled material such as fragments of tiles or concrete.

In some embodiments, the wall 27 is a gabion or a set of gabions. In some embodiments, such a gabion comprises a fragmented material such as pebbles as ballast 26, in a lattice of metallic wires as container 25.

The materials of the constituents of the shelter 1 are chosen taking into account aesthetic constraints and/or cost constraints and/or their respective carbon footprints. Coatings and/or decorative coverings can also be used on at least some portions of the shelter 1.

Pairs of uprights 13, 14 and 15 connect the sole plate 11 and the beam 12 to each other in a generally rigid way. The structure 10 is able to resist, without deterioration, significant traction forces applied upward on the beam 12 and significant push forces applied downward on the beam 12. Such traction forces and push forces can result from wind action on the roof 5. The structure 10 is also able to resist, without deterioration, significant torsional forces resulting from torques applied on the beam 12, around a direction perpendicular to the upright plane M. Such torsional forces can result from wind action on the roof 5.

The wall 27 is able to prevent pillar 3 from being lifted up and/or moved in the presence of significant traction forces applied upward on the beam 12 because of wind action on the roof 5. The wall 27 is also able to prevent pillar 3 from being tilted in the presence of significant torques applied on the beam 12, around a direction perpendicular to the upright plane M, which can result from wind action on the roof 5.

Therefore, as can be seen in FIG. 1, pillars 3 and 4 are separated from each other along a direction d3 crossing the longitudinal direction d1. In this way, pillar 3 has a weight that prevents the shelter 1 from being lifted in the area of this pillar 3. Pillar 4 has a weight that prevents the shelter 1 from being lifted in the area of this pillar 4.

The wall 27 of pillar 3 and wall 27 of pillar 4 effectively prevent the shelter 1 from being moved and/or tilted under the effect of wind. Without being fixed to the ground, the shelter 1 is robust and stable, especially in terms of resistance to the wind, which is advantageous. In addition, the composition of shelter 1 is simple.

A plurality of successive parking spaces P under the roof 5, between pillars 3 and 4, are parallel to the walls 27 of pillars 3 and 4. A large available free surface, on the ground, for parking vehicles, the robustness of the shelter 1 and the stability of this shelter 1 are obtained at the same time. The parking spaces P can be configured for vehicles such as motor cars (not shown).

Pillar 3 and pillar 4 are the only two pillars of shelter 1 in the example shown. According to an embodiment variant of the invention, the shelter comprises at least one additional pillar following pillars 3 and 4 along the direction d3, and a longer roof along this direction d3, so that the number of covered parking spaces P is increased. Preferably, the at least three pillars in succession along the direction d3, which together support the same roof according to this embodiment variant of the invention, are essentially identical examples of pillar 3.

A building method 70 according to an embodiment of the invention is utilised to build the shelter 1.

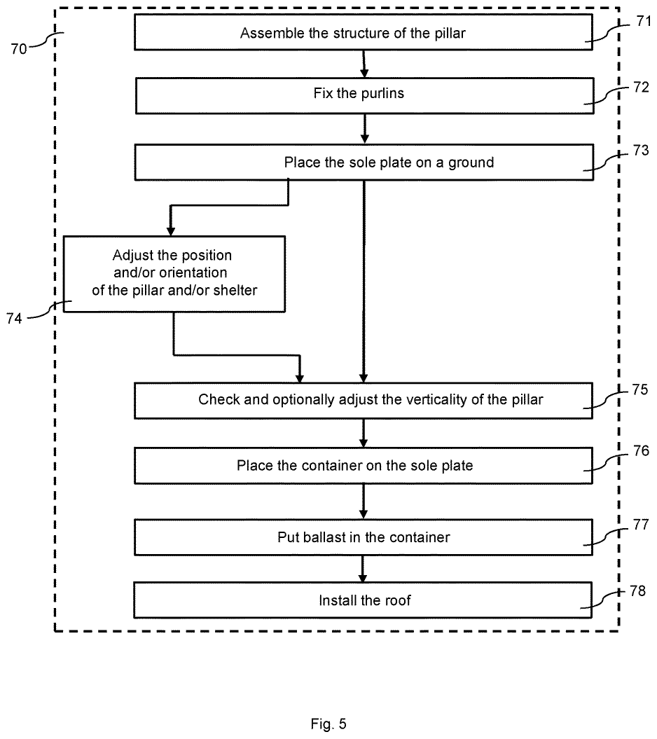

As can be seen in FIG. 5, the building method 70 comprises a step 71 in which the structure 10 of pillar 3 and the structure 10 of pillar 4 are at least partially assembled. In some embodiments, step 71 is carried out in the factory.

In a step 72 of the building method 70, the purlins 40 are fixed to the beam 10 of pillar 3 and to the beam 10 of pillar 4.

In a step 73 of the building method 70, pillars 3 and 4 are erected in order to place the sole plates 11 of these pillars 3 and 4 substantially flat on the parking ground S.

In an optional step 74 of the building method 70, the shelter 1 is moved without ballast 25 and without photovoltaic panels 45 in order to adjust its positioning according to directions parallel to the parking ground S and/or to adjust its orientation around a vertical axis.

A step 75 of the building method 70 takes place after step 73. In step 75, the verticality of pillar 3 in the upright plane M is checked and, if necessary, is adjusted by means of one or more shims among shims 51 and 55. In step 75, the verticality of pillar 4 in the upright plane M is checked and, if necessary, is adjusted by means of one or more shims among shims 51 and 55.

In a step 76 of the building method 70, a container 25 is placed on each of the two sole plates 11 flat on the parking ground S.

In FIG. 1, the containers 25 of pillars 3 and 4 do not yet contain ballast 26.

In a step 77 of the building method 70, ballast 26 is poured into or deposited in the container 25 of pillar 3 while the top of this container 25 is open. In step 77, the container 25 of pillar 3 is closed. In step 77, ballast 26 is poured into or deposited in the container 25 of pillar 4 while the top of this container 25 is open. In step 77, the container 25 of pillar 4 is closed.

According to a first variant described above, step 72 takes place before step 77. According to a second variant, step 72 takes place after step 77. In the optional step 74 of the building method 70 according to this second variant, at least one of the structures 10 of pillars 3 and 4 is moved to adjust its positioning according to directions parallel to the parking ground S and/or to adjust its orientation around a vertical axis.

In a step 78 of the building method 70, the roof 5 is installed on the purlins 40.

It follows from the above that the shelter 1 is easy to build, position, orient and install.

To uninstall the shelter 1, the reverse sequence of steps 78, 77 and 72 is performed, and then the structures 10 of pillars 3 and 4 are removed.

In addition, the shelter 1 can be moved after all or part of the ballast 26 of pillars 3 and 4 has been removed.

It follows from the above that the shelter 1 is able to be uninstalled and/or moved easily. The removal of the shelter 1 leaves no holes in the parking ground S. In particular, it leaves the parking ground S undamaged by holes for elements fastening the shelter 1 to the parking ground S.

In the example shown, the shelter 1 is installed on a parking ground S, which can be, among others, a concrete floor, a tarmac floor, a single-storey floor, a floor with a coating and/or a painted floor. According to some embodiment variants, the shelter 1 is installed on a floor of gravel, sand or grasscrete, etc. The shelter 1 thus has the advantage of being adaptable to various terrains once these are sufficiently compacted to withstand the combination of the weight of pillar 3 and the various loads exerted on this pillar 3.

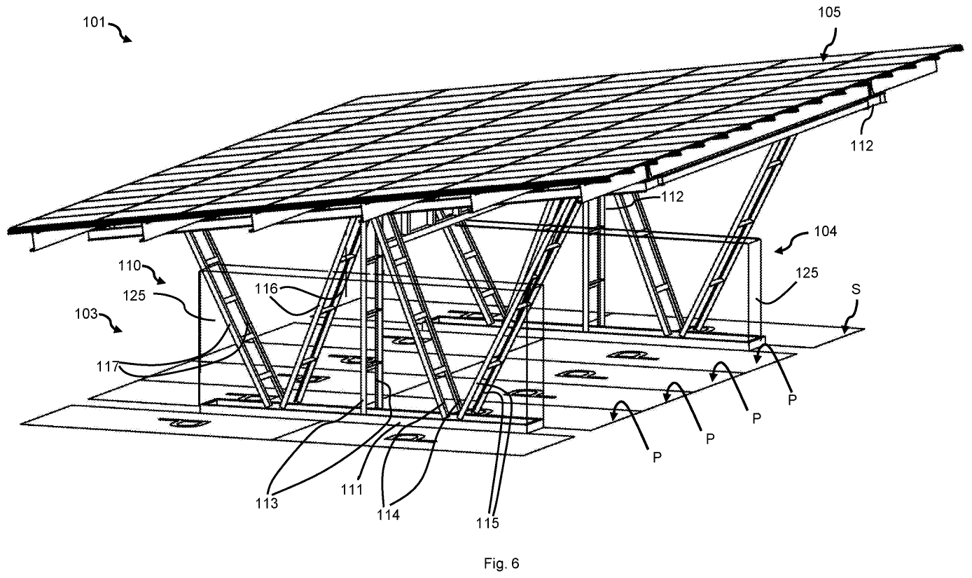

A shelter 101 is shown without its ballast in FIG. 6. The shelter 101 is according to a second embodiment of the invention. In the following, the shelter 101 is only described by what distinguishes it from the shelter 1. In addition, when a referenced part of the shelter 101 is identical or equivalent to a referenced part of the shelter 1, its reference is constructed by adding 100 to the reference designating this referenced part on the shelter 1.

In FIG. 6, the containers 125 of pillars 103 and 104 do not yet contain ballast. The shelter 101 is complete when each container 125 contains such ballast (not shown).

In pillar 103 of the shelter 101, the structure 110 comprises a pair of uprights 116 and a pair of uprights 117, in addition to the pairs of uprights 113, 114 and 115. The pairs of uprights 113, 114, 115, 116 and 117 rigidly connect the sole plate 111 and the beam 112 of pillar 103 to each other. Together, the pairs of uprights 114, 115, 116 and 117 of pillar 103 essentially form an upright W.

The shelter 101 is wider than shelter 1. Two rows of parking spaces P parallel to one other are located next to each other under the roof 105, between pillars 103 and 104.

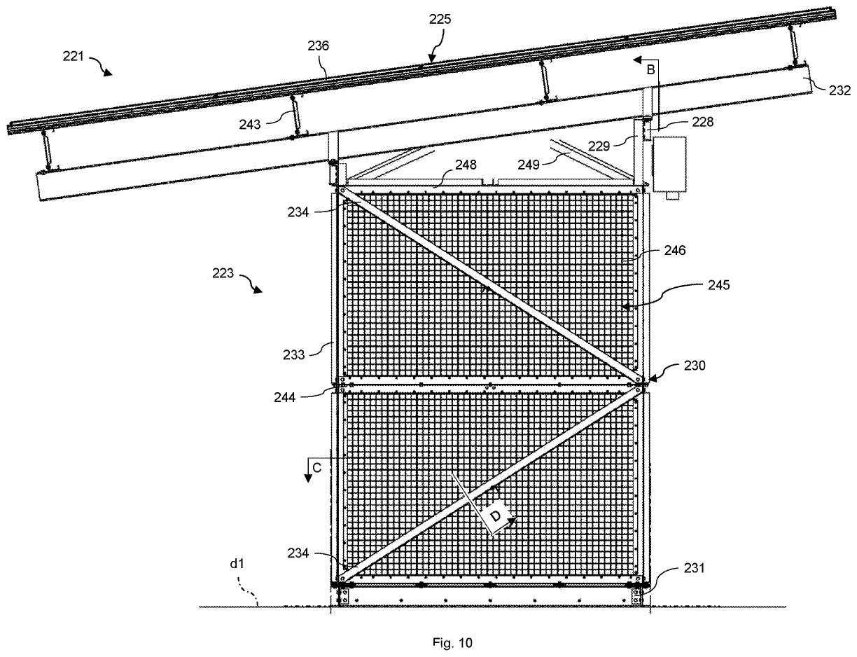

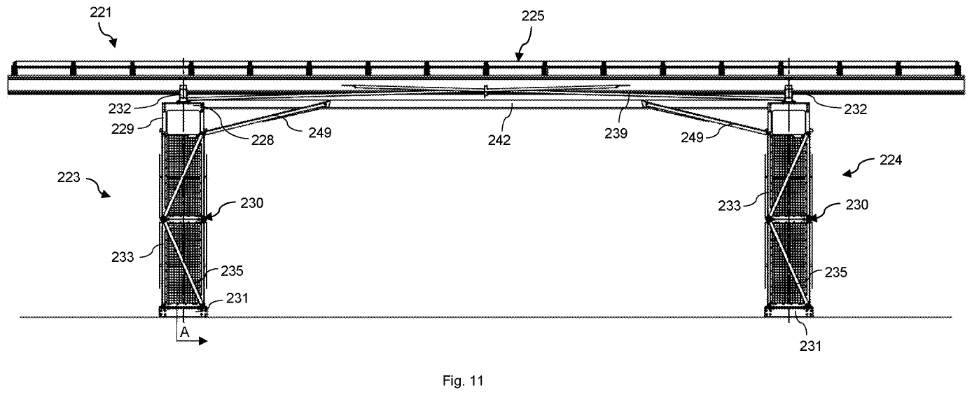

Throughout the description, the term “front” refers to what is shown on the right in FIG. 10 and “back” refers to what is shown on the left. Thus, the roof of the shelter slopes from the front to the back. FIG. 11 is therefore a front elevation view. The term “lateral” refers to what is on the right or left of each pillar in FIG. 11. For example, FIG. 10 comprises a view of a lateral surface of a pillar. The term “upper” refers to what is located at, or oriented towards, the top when the shelter is positioned on a ground, for example a parking area, and the term “lower” to what is located at, or oriented towards, the bottom in this same configuration of the shelter. The term “frontal” refers to what is located at, or oriented towards, the front or back of the shelter. The terms “interior” and “exterior” are used with reference to each pillar, not to the entire shelter. Thus, the space between two pillars is exterior to the pillars.

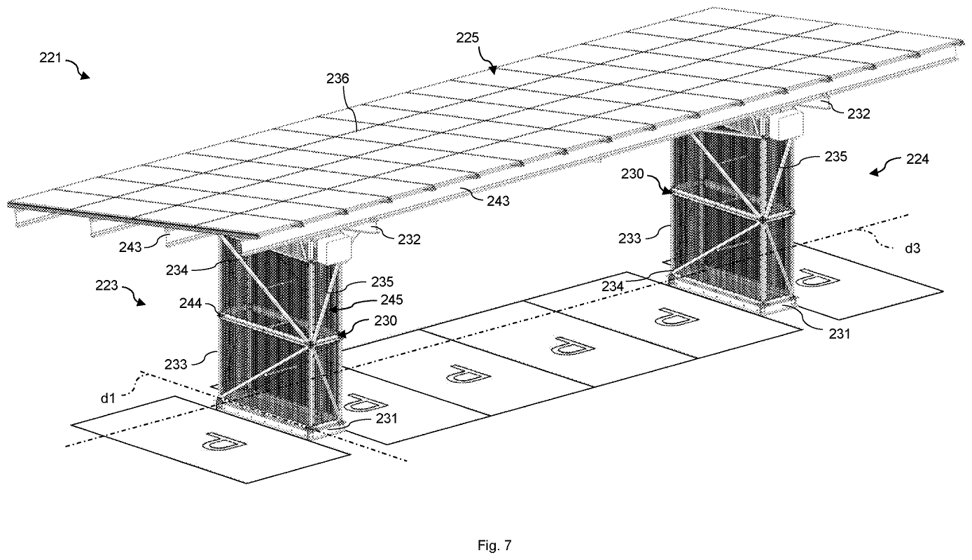

It is now noted that FIGS. 7 to 16 are to scale, but they have different scales. In FIGS. 7 to 12 and 14 to 16, a shelter 221 is shown during positioning: the shelter 221 does not yet contain ballast and is placed on a parking ground S. The shelter 221 comprises a pillar 223 and a pillar 224, which together support a roof 225. In the shelter 221 shown, pillars 223 and 224 are identical. In what follows, only pillar 223 is described, for reasons of clarity. In addition, when they are identical or equivalent, a referenced part of pillar 223 and a referenced part of pillar 224 are designated by the same reference.

Pillar 223 has a structure 230 comprising a sole plate 231, an upper beam 232 and a plurality of vertical uprights 233, which connect the sole plate 231 to the beam 232. The structure 230 also comprises lateral bracing diagonals 234 and frontal bracing diagonals 235 that improve structural integrity, distribute the loads and resist the lateral forces exerted on the structure 230.

The sole plate 231, beam 232, uprights 233, diagonals 234 and 235, and any intermediate parts are held together, for example by bolting, such that the structure 230 is rigid.

The sole plate 231 is elongated. Its longitudinal direction on the ground is referenced d1.

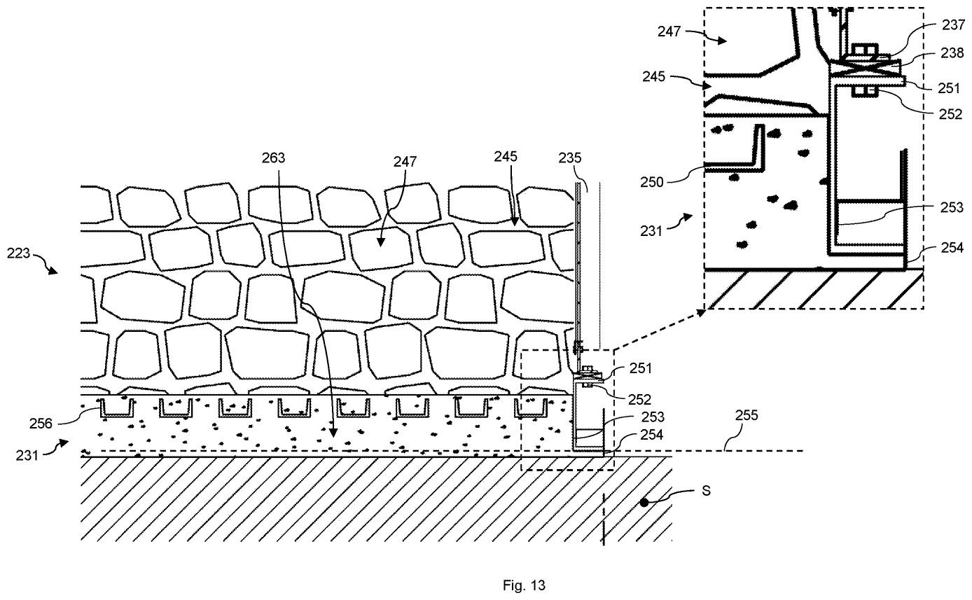

The sole plate 231 is a rigid sub-structure of the structure 230. The sole plate 231 comprises a rectangular frame formed of four lower horizontal cross-members 251, also known as profiles, (see FIG. 13), and a series of interior cross-members 256, each cross member having two opposite ends at least held down by this frame. In the example shown, each end of any cross-member 256 is held down by an interior edge fixed to the lower cross-members 251 of this frame which are parallel to the longitudinal direction d1.

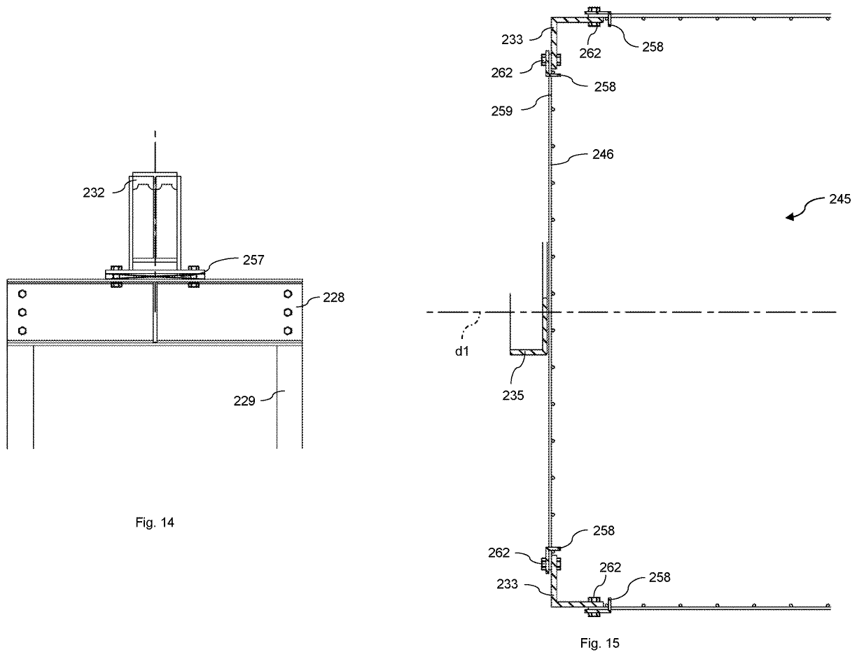

Each of the uprights 233 comprises two upright bars that are superimposed and parallel to one another. The lower upright bar has a lower end fixed directly or indirectly to the sole plate 231. The upper upright bar has an upper end fixed directly or indirectly to the beam 232. In the figures, and especially in FIGS. 10 and 14, it can be seen that the vertical uprights 233 are connected to the beam 232 by means of upper vertical uprights 229 and a horizontal transverse spar 228.

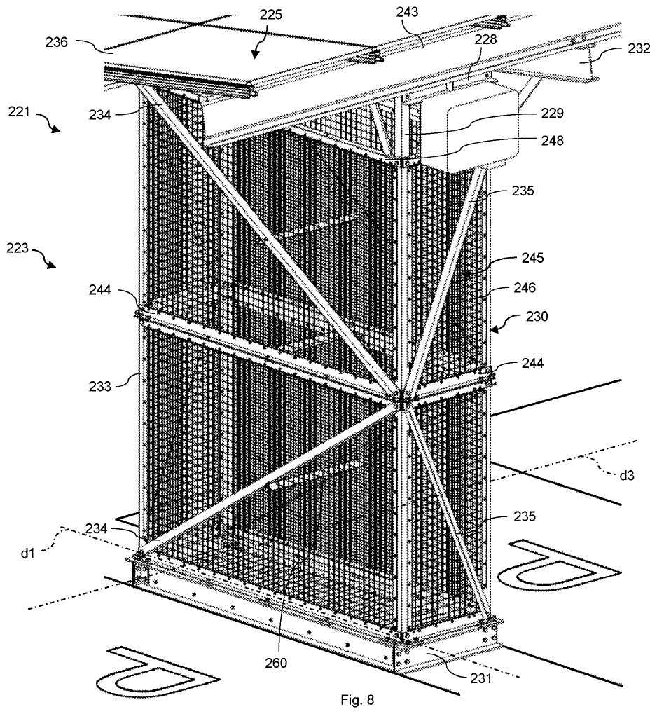

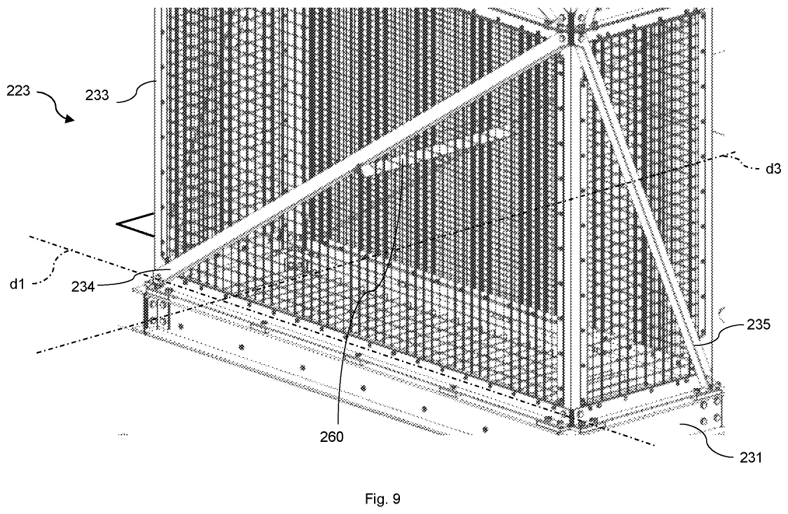

Intermediary horizontal cross-members 244 that are lateral, i.e. parallel to direction d1, or frontal, i.e. perpendicular to the lateral cross-members, connect the upper ends of the lower upright bars and the lower ends of the upper upright bars. The lower lateral diagonals 234 connect a lower end of a lower upright bar to an upper end of another lower upright bar located in the same plane parallel to direction d1. The upper lateral diagonals 234 connect a lower end of an upper upright bar to an upper end of another upper upright bar located in the same plane parallel to direction d1. The lower frontal diagonals 235 connect a lower end of a lower upright bar to an upper end of another lower upright bar located in the same plane perpendicular to direction d1. The upper frontal diagonals 235 connect a lower end of an upper upright bar to an upper end of another upper upright bar located in the same plane perpendicular to direction d1. Preferably, a lower lateral diagonal 234, an upper lateral diagonal 234, a lower frontal diagonal 235 and an upper frontal diagonal 235 come together at the same end of two intermediary horizontal cross-members 244, one lateral and the other frontal, as shown in FIGS. 8 and 9.

Pillar 223 comprises a container 245, which is elongated so as to have the same longitudinal direction d1 as the sole plate 231. The container 245 rests on the sole plate 231, over the sole plate's entire length. The container 245 rests in particular on the lower cross-members 251.

Pillar 223 of the completed shelter 221 comprises ballast 247 placed in the container 245 so that the container 245 applies the weight of the ballast 247 on the sole plate 231.

The container 245 and the ballast 247 together form a wall. Like the container 245, the wall has the same longitudinal direction d1 as the sole plate 231.

As can be seen in FIGS. 7 to 9, the container 245 runs between the uprights 233, between the lateral diagonals 234 and between the frontal diagonals 235.

As can be seen in FIGS. 8 to 10, a lower end of the lower bar of each vertical upright 233 and a lower end of each lower lateral diagonal 234 and lower frontal diagonal 235 are immobilised on the sole plate 231, which maintains a separation distance between these lower ends, along the longitudinal direction d1 of the wall.

An upper end of the upper bar of each upright 233 and an upper end of each upper lateral diagonal 234 or upper frontal diagonal 235 are immobilised on an upper horizontal cross-member 248 supporting the beam 232. This upper cross-member 248 maintains a separation distance between these upper ends, along the longitudinal direction d1.

Several purlins 243 of the roof 225 rest on the beam 232, to which these purlins 243 are fixed, for example by bolting.

As can be seen in FIGS. 7 to 9, the roof 225 comprises a roof covering that advantageously comprises photovoltaic panels 236.

The structure 230 is mainly or completely made of metal parts. Other materials are also possible. For example, according to one variant, the structure 230 is mainly or completely made of wooden parts.

The purlins 243 are metal parts. Other materials are also possible. For example, according to one variant, the purlins 243 are wooden parts.

The container 245 comprises partitions, each selected from among a screen, a lattice of interwoven wires or rods, a lattice of battens, a fabric (geotextile, net, etc.), at least one sheet and at least one panel, for example made of wood and/or plastic. In the embodiment shown, the container comprises partitions formed of screens 246. According to an advantageous possibility, the rods of the screen 246 are metallic. Preferably, these rods are made of steel selected from among stainless steel, galvanised steel and tinned steel. According to a first variant, the container 245 comprises a single compartment. According to a second variant, the container 245 comprises a plurality of compartments. According to a third variant which can be combined with any of these first and second variants, the bottom of the container 245 is a part which can be separated or is initially separate from the rest of this container 245 and which is installed separately, under or between the lower cross-members 256 of the sole plate 231, by fixing it to the underside or to the lower parts of these lower cross-members 251. When this is the case, at least one portion of the ballast 247 bears directly on the sole plate 231, once the pillar 223 has been completed.

The ballast 247 comprises a first material consisting of rocks, pebbles, stones, gravel, sand, concrete breeze blocks, at least one concrete block and/or recycled material such as fragments of tiles or concrete.

According to an advantageous possibility, the wall is a gabion or a set of gabions. According to an advantageous possibility, such a gabion comprises a first fragmented material such as pebbles as ballast 247, between metallic grids or lattices of metallic wires as container 245.

The materials of the constituents of the shelter 221 are chosen taking into account aesthetic constraints and/or cost constraints and/or their respective carbon footprints. Coatings and/or decorative coverings can also be used on at least some portions of the shelter 221.

The uprights 233 and the diagonals 234 and 235 connect the sole plate 231 and the beam 232 to each other in a rigid way. The structure 230 is able to resist, without deterioration, significant traction forces exerted upward on the beam 232 and significant push forces exerted downward on the beam 232. Such traction forces and push forces can result from wind action on the roof 225. The structure 230 is also able to resist, without deterioration, significant torsional forces resulting from torques exerted on the beam 232, around a direction perpendicular to the vertical plane comprising direction d1. Such torsional forces can result from wind action on the roof 225.

The wall is able to prevent pillar 223 from being lifted up and/or moved in the presence of significant traction forces exerted upward on the beam 232 because of wind action on the roof 225. The wall is also able to prevent pillar 223 from being tilted in the presence of significant torques exerted on the beam 232, around a direction perpendicular to the vertical plane comprising direction d1, which can result from wind action on the roof 225.

Therefore, as can be seen in FIGS. 7 and 11, pillars 223 and 224 are separated from each other along a lateral direction d3 perpendicular to the longitudinal direction d1. In this way, pillar 223 has a weight that prevents the shelter 221 from being lifted in the area of this pillar 223. Pillar 224 has a weight that prevents the shelter 221 from being lifted in the area of this pillar 224.

The wall of pillar 223 and the wall of pillar 224 effectively prevent the shelter 221 from being moved and/or tilted under the effect of wind. Without being fixed to the ground, the shelter 221 is robust and stable, especially in terms of resistance to the wind, which is advantageous. In addition, the composition of shelter 221 is simple.

Pillar 223 and pillar 224 are the only two pillars of shelter 221 in the example shown. According to an embodiment variant of the invention, the shelter comprises at least one additional pillar following pillars 223 and 224 along the direction d3, and a longer roof along this direction d3, so that the number of covered parking spaces P is increased. Preferably, the at least three pillars in succession along the direction d3, which together support the same roof according to this embodiment variant of the invention, are identical examples of pillar 223.

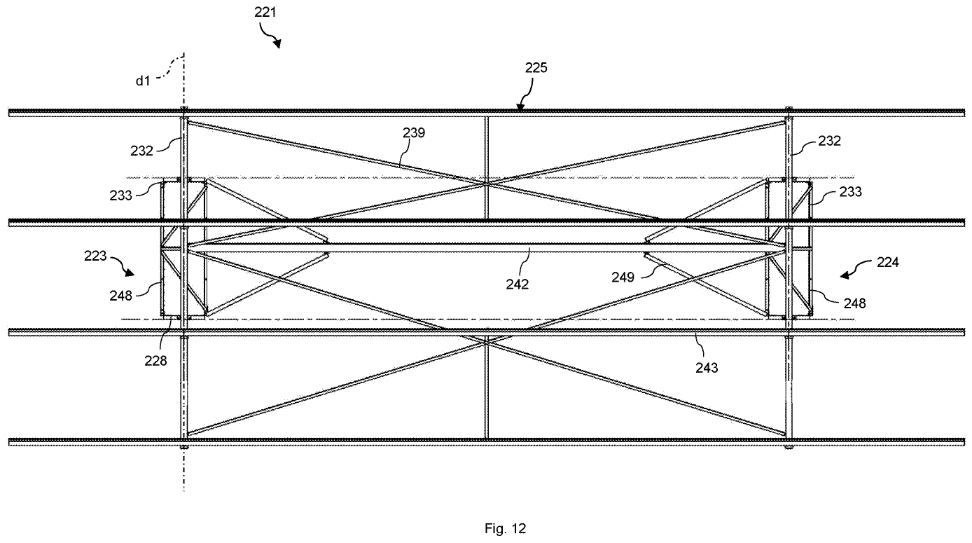

As shown in FIGS. 11 and 12, a beam 242 connects the beams 232 of pillars 223 and 224. This beam 242 is connected to the structures 230 of pillars 223 and 224 by diagonals 249. Four profiles 239 connect the structure 230 of one of the pillars, 223 or 224, to the end of the beam 232 of the other pillar, 224 or 223, respectively. These diagonals 249 and these profiles 239 play a role in the bracing of the shelter 221.

A plurality of successive parking spaces P under the roof 225, between pillars 223 and 224, are parallel to the median planes of the walls of pillars 223 and 224. A large available free surface, on the ground, for parking vehicles, the robustness of the shelter 221 and the stability of this shelter 221 are obtained at the same time. The parking spaces P can be configured for vehicles such as motor vehicles (not shown).

As can be seen in FIG. 13, the ballast 247 placed in the container 245 comprises a first material.

The sole plate 231 comprises an upper perforated support. For example, this upper support is formed of parallel profiles 256 or a metal screen. The sole plate 231 comprises, below this perforated support, a second fragmented material, the fragments of which are configured to pass through the through-openings of the perforated support. For example, this second fragmented material consists of sand, rocks or small pebbles.

In the case where, as shown in FIG. 13, the ballast 247 placed in the container 245 comprises a graded fragmented material, the fragments of which conform to a geometric size, the distance between these profiles 256 or the largest dimension of the openings of the screen is less than the smallest dimension of the smallest graded fragment of the first material and, preferably, less than half this value. In one example of this case, the ballast 247 consists of stones, pebbles, concrete blocks or fragments of tiles. Typically, these fragments have, depending on this geometric size, dimensions of between 100 mm and 200 mm. In this case, the distance between these profiles 256 or the largest dimension of the openings of the screen is, for example, less than 100 mm, and preferably less than 50 mm.

In the case where the first material is fragmented, preferably the largest dimension of the fragments of the second fragmented material 263 is less than half the smallest dimension of the smallest graded fragment 247 of the first fragmented material.

Thanks to the use of this second fragmented material, which is inserted into the sole plate 231 first of all, the adjustment of the verticality of each pillar, 223 or 224, can be carried out by slightly lifting up the lowest portion of the sole plate 231 so that fragments of the second fragmented material pass, by gravity, (“flow”) below this portion and keep it slightly raised when this lifting up is released. In addition, the fragments of the second material can absorb the shocks of the first material, when it is dropped into the container 245. It is only after the pillar has been adjusted that the first material 247 is inserted into the container 245 of this pillar. In the case of a first fragmented material, it is typically inserted into the container 245 by pouring the contents of a big bag at the location of the upper surface of the container 245.

As shown in FIG. 13, in some preferred embodiments, the sole plate 231 also comprises on its rim in contact with the ground S, a lower bearing surface 255 resting on the ground, typically a horizontal surface, shown by dashed lines in FIG. 13. This lower bearing surface 255 comprises, in FIG. 13, the sides of four “U”-shaped peripheral profiles 251 inclined at an angle of 90 degrees to the exterior of the sole plate. These profiles 251, also known as lower cross-members, are fixed to each other and to the uprights 233 by bolts 252.

The lower end of the upright 233 comprises a fixing flange 237 which is bolted to a profile 251 of the sole plate 231. At least one shim 238 is placed between the fixing flange 237 and the sole plate 231. In a variant, no shim is placed between the fixing flange 237 and the sole plate 231. Each shim 238 makes it possible to adjust the position of the pillar 223 relative to the vertical in the vertical plane comprising the direction d1, for example if the parking ground S is uneven. Pillar 223 thus comprises means allowing a vertical adjustment, these means comprising the fixing flanges 237.

Each shim 238 also makes it possible to adjust the height of pillar 223 relative to pillar 224 and, in particular, to position these two pillars 223 and 224 at the same height, for example if the parking ground S is uneven. This possibility of adjustment is even more useful and advantageous in the case where the shelter comprises more than two successive pillars 223 and 224. This possibility of adjustment is even more useful and advantageous in the case where at least three pillars in succession together support the same one or more rectilinear purlins 243 of the shelter.

The sole plate 231 comprises, on the exterior of this lower bearing surface 255, a vertical or oblique rigid skirt 254 extending, downwards, at least to the location of the lower bearing surface 255. This rigid skirt 254 retains the fragments of the second material when the sole plate 231 is lifted up or in the event of water run-offs on the ground following heavy rain.

In the embodiment shown in FIG. 13, the rigid skirt 254 is vertical and extends, downwards, beyond the level of the lower bearing surface 255. The rigid skirt 254 is fixed to the “U”-shaped profiles 251, for example by bolting, on a “Z”-shaped part 253 having right angles, itself fixed to the vertical interior surface of the profiles 251.

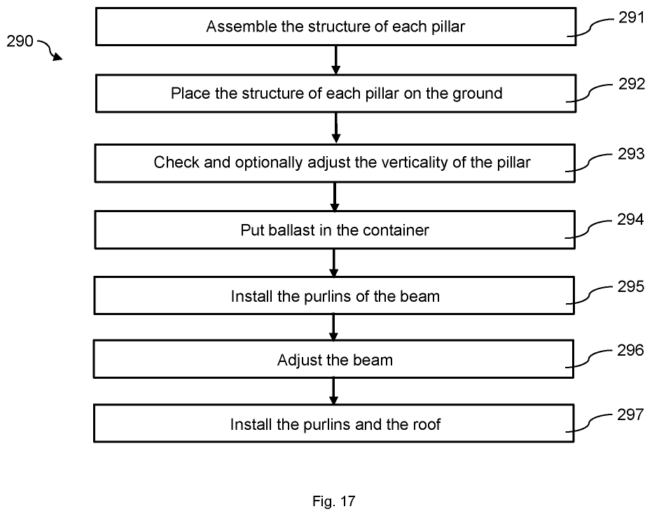

The container 245 comprises frontal surfaces and lateral surfaces that surround a volume intended to receive the ballast 247. As shown in FIGS. 9 and 17, the container 245 comprises at least one interior brace 260 traversing the volume of the container 245 between two of these surfaces. The container 245 comprises an attachment means 261 for attaching each end of each said interior brace 260 to one of the surfaces of the container 245 between which this interior brace 260 extends.

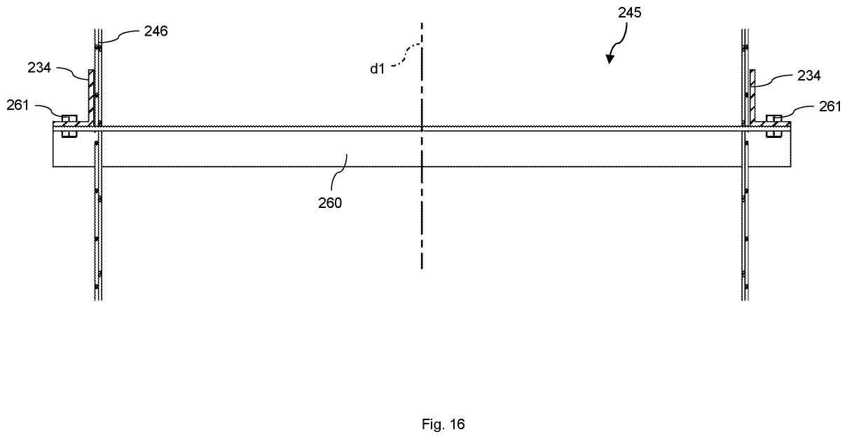

In the embodiment shown in FIGS. 9 and 16, each interior brace 260 connects two lateral surfaces. However, in other embodiments, at least one brace 260 within the volume of the container connects two frontal surfaces, or one frontal surface and one lateral surface, even a profile 251 of the sole plate to a frontal or lateral surface.

In some embodiments, at least one interior brace 260 can be configured to deform under the impact of fragments of the first material falling from the top of the container 245.

As shown in FIGS. 7 to 10, the container 245 comprises uprights 233 connecting the sole plate 231 and the beam 232. Preferably and as shown in FIG. 15, the container 245 comprises:
on at least one upright 233, a comb 258 having teeth perpendicular to the surface of the container and turned towards the interior of the container; and
at least one screen 246 comprising aligned through-openings 259 traversed by teeth of a said comb.

Preferably, the two “L”-shaped surfaces of each upright 233 bears a comb 258, each screen 246 comprising aligned through-openings traversed by the teeth of a said comb. As shown in FIG. 15, each comb 258 can form a surface of an “L”-shaped profile having an angle of 90 degrees and whose surface without teeth is bolted to a surface of an upright 233, by means of a bolt 262.

A building method 290 according to an embodiment of the invention is utilised to build the shelter 221 on a parking area. As can be seen in FIG. 17, the building method 290 comprises a step 291 during which the structure 230 of pillar 223 and the structure 230 of pillar 224 are at least partially assembled. According to an advantageous possibility, step 291 is carried out in the factory.

During a step 292, the structures of pillars 223 and 224 are placed, sole plates flat, on the parking ground S. Then, the second fragmented material 263 is inserted into the sole plate 231 of each pillar 223 and 224.

During a step 293, the verticality of each pillar 223 and 224 in the vertical plane passing via the direction d1 is checked. If necessary, thanks to the use of the second fragmented material, which is inserted into the sole plate 231 first of all, the adjustment of the verticality of each pillar, 223 or 224, can be carried out by slightly lifting up the lowest portion of the sole plate 231 so that fragments of the second fragmented material pass, by gravity, (“flow”) below this portion and keep it slightly raised when this lifting up is released. Possibility this verticality is also adjusted as described with reference to FIG. 13 with the lower shim.

During a step 294, ballast 247 is poured into or deposited in the container 245 of each pillar 223 and 224.

During a step 295, the purlins 243 are fixed to the beam 232 of pillar 223 and to the beam 232 of pillar 224. During a step 296, the beam 232 is adjusted above the horizontal transverse spar 228 as shown in FIG. 14, possibly by affixing an upper shim 257. In this way good linearity of the roof 225 and, if applicable, solar panels 236 is ensured, in particular when there are at least three pillars. Then, during a step 297, the roof 225 is installed on the purlins 243, including the photovoltaic panels 236, if any.

It follows from the above that the shelter 221 is easy to build, position, orient and install. In addition, the shelter 221 can be moved after all or part of the ballast 247 of pillars 223 and 224 has been removed. It follows from the above that the shelter 221 is able to be uninstalled and/or moved easily. The removal of the shelter 221 leaves no holes in the parking ground S. In particular, it leaves the parking ground S undamaged by holes for elements fastening the shelter 221 to the parking ground S.

In the example shown, the shelter 221 is installed on a parking ground S, which can be, among others, a concrete floor, a tarmac floor, a single-storey floor, a floor with a coating and/or a painted floor. According to some embodiment variants, the shelter 221 is installed on a floor of gravel, sand or grasscrete, etc. The shelter 221 thus has the advantage of being adaptable to various terrains once these are sufficiently compacted to withstand the combination of the weight of pillar 223 and the various loads exerted on this pillar 223.

### DESCRIPTION OF THE INVENTION

At least one aim of the invention is to facilitate the installation of a shelter. The shelter defined above has the advantage that it can be at least partially preassembled, i.e. at least partially assembled prior to its installation.

1. A shelter comprising:
a roof;
a pillar which at least partially supports the roof and which comprises:
a sole plate;
a beam higher than the sole plate;
a plurality of uprights connecting the sole plate and the beam to each other;
a container; and
ballast placed in the container so that the sole plate holds at least some of the weight of this ballast;
wherein the container and the ballast run between the upright, and the ballast comprises a gabion or a set of gabions comprising a fragmented material and the container comprises a lattice of interwoven metallic wires, a lattice of battens, sheets and/or wooden panels.

2. The shelter according to claim 1, wherein the container and the ballast together form a wall.

3. The shelter according to claim 1, wherein a lower end of a first upright of said plurality of uprights and a lower end of a second upright of said plurality of uprights are immobilised on the sole plate, the sole plate maintaining a separation distance between the lower end of the first uprights and the lower end of the second upright.

4. The shelter according to claim 3, wherein, together, the first upright and the second upright form a V whose opening faces downwards.

5. The shelter according to claim 2, wherein a lower end of a first upright of said plurality of uprights and a lower end of a second upright of said plurality of uprights are immobilised on the sole plate, the sole plate maintaining a separation distance between the lower end of the first uprights and the lower end of the second upright, and wherein the separation distance between the lower end of the first upright and the lower end of the second upright is along a longitudinal direction of the wall.

6. The shelter according to claim 5, wherein an upper end of the second upright and an upper end of a third upright of said plurality of uprights are immobilised on the beam, the beam having a longitudinal direction which is substantially parallel to a same vertical plane as the longitudinal direction of the wall, the beam maintaining a separation distance along the longitudinal direction of the beam, between the upper end of the second upright and the upper end of the third upright.

7. The shelter according to claim 6, wherein, together, the second upright and the third upright form a V whose opening faces upwards.

8. The shelter according to claim 1, wherein the roof comprises a roof covering that comprises photovoltaic panels.

9. The shelter according to claim 1, wherein the ballast comprises a first material, the sole plate comprises an upper perforated support and, below this perforated support, a second fragmented material, the fragments of which are adapted to pass through the through-openings of this perforated support.

10. The shelter according to claim 9, wherein the sole plate comprises a second fragmented material and a lower bearing surface resting on the ground and, on the exterior of this lower bearing surface, a vertical or oblique rigid skirt extending, downwards, at least to the location of the lower bearing surface.

11. The shelter according to claim 10, wherein the rigid skirt is vertical, the bearing surface comprises “U”-shaped lateral surfaces inclined at 90 degrees and/or the rigid skirt is held in position by a “Z”-shaped part having right angles, itself fixed to the vertical interior surface of the profiles.

12. The shelter according to claim 9, wherein the first material is fragmented and graded, its fragments conforming to a geometric size, and in which the through-openings of the perforated support are configured to prevent the passage of the first material.

13. The shelter according to claim 12, wherein the largest dimension of the fragments of the second fragmented material is less than half the smallest dimension of the smallest graded fragment of the first material.

14. The shelter according to claim 9, wherein the perforated support comprises parallel profiles.

15. The shelter according to claim 9, wherein the first material is fragmented and graded, its fragments conforming to a geometric size, and in which the through-openings of the perforated support are configured to prevent the passage of the first material, wherein the perforated support comprises parallel profiles, and wherein the distance between the profiles is less than the smallest dimension of the smallest graded fragment of the first fragmented material.

16. The shelter according to claim 15, wherein the distance between the profiles is less than half the smallest dimension of the smallest graded fragment of the first fragmented material.

17. The shelter according to claim 9, wherein the container comprises frontal surfaces and lateral surfaces, and at least one interior brace traversing the volume of the container between two of said surfaces, the container comprising an attachment means for attaching each end of said interior brace to one of the surfaces between which this interior brace extends.
In some optional embodiments, the container comprises:
on at least one upright, a comb having teeth perpendicular to the surface of the container and turned towards the interior of the container; and
at least one screen comprising aligned through-openings traversed by teeth of a said comb.

18. The shelter according to claim 9, wherein the sole plate comprises a lower bearing surface resting on the ground and, on the exterior of this lower bearing surface, a vertical or oblique rigid skirt extending, downwards, at least to the location of the lower bearing surface.

19. A parking space for a vehicle, characterised in that it comprises the shelter according to claim 1, and a parking area for a vehicle located under the roof of the shelter.

20. A method for building the shelter according to claim 1, that comprises steps wherein:
a) the sole plate is placed on a ground,
b) the uprights are attached to the sole plate,
c) the container is assembled between the uprights, then
d) the ballast is put in the container that is in place relative to the sole plate so that the sole plate holds at least part of the weight of the ballast once this ballast is in the container, and
e) the beam and the roof are attached to the uprights.
